(19) United States
(12) Patent Application Publication
(10) Pub. No.: US 2014/0379241 A1
(43) Pub. Date: Dec. 25, 2014

(54) HYDRAULIC ACCUMULATOR TEMPERATURE ESTIMATION FOR CONTROLLING AUTOMATIC ENGINE STOP/START

(71) Applicant: GM GLOBAL TECHNOLOGY OPERATIONS LLC, Detroit, MI (US)

(72) Inventor: Paul G. Otanez, Troy, MI (US)

(21) Appl. No.: 13/922,511

(22) Filed: Jun. 20, 2013

(51) Int. Cl. F02D 29/02; F02D 41/30

(52) U.S. Cl. CPC F02D 29/02; F02D 41/30; F02D 2700/07; F02D 2700/0215
USPC 701/104; 701/102

(57) ABSTRACT

A method of preventing an automatic engine stop includes estimating a temperature of a volume of fluid within a hydraulic accumulator that is in selective fluid communication with a fluidly-actuated torque-transmitting device. The torque-transmitting device is coupled to an internal combustion engine and configured to selectively transmit a torque from the engine to a vehicle wheel. The method further includes comparing the estimated fluid temperature to a temperature range, and preventing the internal combustion engine from automatically stopping if the estimated fluid temperature is outside of the temperature range.

### TECHNICAL FIELD

The present invention relates to a method of estimating a fluid temperature within a hydraulic accumulator, and more particularly to a method of controlling an automatic engine stop/start using the estimation.

### BACKGROUND

A typical automatic transmission includes a hydraulic control system that may be used to fluidly engage one or more clutches, brakes, or other torque transmitting devices. The hydraulic control system may include one or more fluid pumps and one or more electronically actuated valves, which may cooperate to selectively provide a pressurized fluid, such as oil, through a fluid circuit to the one or more fluidly actuated torque transmitting devices. The one or more fluid pumps may be selectively driven by either the engine of the motor vehicle, or by an on-board electrical power source to pressurize the hydraulic fluid.

In order to increase the fuel economy of motor vehicles, it may be desirable to stop the engine during certain circumstances, such as when stopped at a red light or idling. However, during this automatic stop, an engine-driven pump may no longer be driven by the engine. Accordingly, hydraulic fluid pressure within the hydraulic control system may drop, which may, in turn, cause the clutches and/or brakes within the transmission to be fully disengaged. As the engine restarts, these clutches and/or brakes may take time to reengage, resulting in slippage and/or delay between engagement of the accelerator pedal or release of the brake and the movement of the motor vehicle.

### SUMMARY

A method of preventing an automatic engine stop includes estimating a temperature of a volume of fluid within a hydraulic accumulator that is in selective fluid communication with a fluidly-actuated torque-transmitting device. The torque-transmitting device is coupled to an internal combustion engine and configured to selectively transmit a torque from the engine to a vehicle wheel. The method further includes comparing the estimated fluid temperature to a temperature range, and preventing the internal combustion engine from automatically stopping if the estimated fluid temperature is outside of the temperature range.

In one configuration, estimating a temperature of the volume of fluid may include computing a first temperature change of the volume of fluid that is attributable to heat transfer from the volume of fluid to a surrounding environment. Additionally, fluid may be introduced into the volume of fluid from a hydraulic circuit. In that case, estimating a temperature of the volume of fluid may further include computing a second temperature change in the volume of fluid that is attributable to fluid mixing with the introduced fluid.

If the estimated fluid temperature is outside of the temperature range, fluid within the hydraulic accumulator may be discharged to mix with fluid in the hydraulic circuit.

Similarly, a vehicle may include an internal combustion engine, a transmission, a hydraulic control system, and a control module. The internal combustion engine may be configured to combust a fuel to provide a mechanical rotary output, and may automatically stop combusting the fuel if a vehicle motion is prevented by a braking device. The transmission is coupled with the internal combustion engine and may include a fluidly actuated torque transmitting device configured to selectively transmit the rotary output of the internal combustion engine to a vehicle wheel. The hydraulic control system may be in fluid communication with the torque transmitting device, and may include a fluid circuit in fluid communication with a fluid sump and a hydraulic accumulator. The hydraulic accumulator is configured to selectively retain a volume of fluid, and selectively discharge it to the fluid circuit.

The control module is in communication with the hydraulic control system and with the internal combustion engine. The control module is configured to: maintain an estimate of a temperature of the volume of fluid within the hydraulic accumulator; estimate a change in the temperature of the volume of fluid within a hydraulic accumulator using the estimate of a temperature of the volume of fluid, an ambient temperature, and a temperature of a fluid within the fluid sump; update the estimate of temperature of the volume of fluid with the estimated change in temperature; compare the updated estimated fluid temperature to a temperature range; and prevent the internal combustion engine from automatically stopping if the estimated fluid temperature is outside of the predefined temperature range.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle including an engine, transmission, and hydraulic control system.

FIG. 2A is a schematic diagram of a hydraulic accumulator storing a volume of fluid.

FIG. 2B is a schematic diagram of a hydraulic accumulator releasing a hydraulic fluid.

FIG. 2C is a schematic diagram of a hydraulic accumulator receiving a hydraulic fluid.

FIG. 3 is a schematic flow diagram of a method of estimating a temperature of a fluid within a hydraulic accumulator.

FIG. 4 is a schematic flow diagram of a method of preventing an autostop in an internal combustion engine using an estimated temperature of a fluid within a hydraulic accumulator.

### DETAILED DESCRIPTION

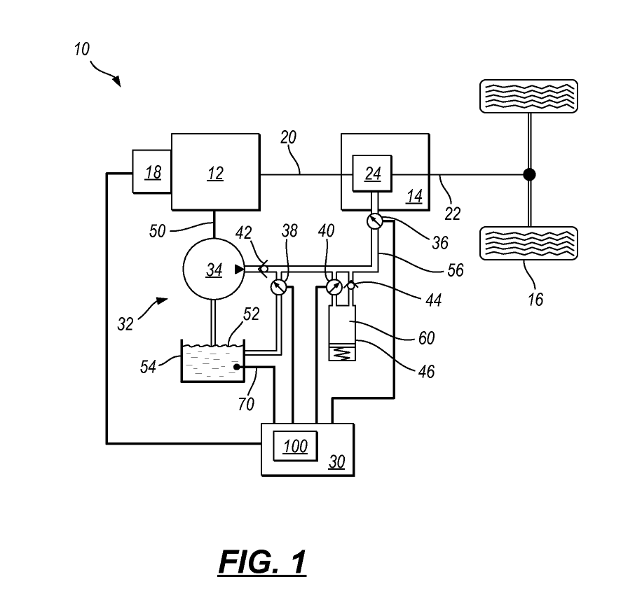

Referring to the drawings, wherein like reference numerals are used to identify like or identical components in the various views, FIG. 1 schematically illustrates a vehicle 10 that may include an internal combustion engine 12 in power-flow communication with a transmission 14, and a plurality of drive wheels 16. The engine 12, transmission 14, and drive wheels 16 may cooperate to provide a motive force to the vehicle 10. The internal combustion engine 12 may be a spark-ignited gasoline engine, a compression-ignited diesel engine, and/or may be configured to operate by combusting one or more other volatile compounds/fuels, such as alcohol, ethanol, methanol, biofuel, or any other fuel known in the art. The engine 12 may include or be coupled with a starting device 18 that may mechanically rotate a crankshaft to begin cycling the engine 12. The starting device 18 may include a hydrodynamic device, such as a fluid coupling or torque converter, a wet dual clutch, and/or an electric motor.

In one configuration, the transmission 14 may be a multi-gear automatic transmission that may selectively transmit a torque from an input shaft 20 of the transmission 14 to an output shaft 22 of the transmission 14. In some configurations, the transmission 14 may include one or more electric motors capable of augmenting the torque produced by the engine 12; alternatively, or in addition, the transmission may be for example, a dual clutch transmission or a continuously variable transmission.

The transmission 14 may include one or more fluidly-actuated, torque-transmitting devices 24, used to selectively couple the input shaft 20 and output shaft 22 at a desired transmission ratio. Such torque-transmitting devices 24 may include one or more clutches or brakes that may selectively engage or disengage when a pressurized fluid is provided to an apply volume associated with the device 24. The transmission 14 may further include a plurality of gear sets, with each set respectively including one or more individual gears and/or planetary gear sets.

The vehicle 10 may further include a control module 30, such as an engine control module (ECM), transmission control module (TCM), and/or a hybrid control module (HCM) that may serve to control the operational behavior of the engine 12, transmission 14, and/or a hydraulic control system 32 associated with the engine 12 and transmission 14. The control module 30 may be embodied as one or multiple digital computers or data processing devices, having one or more microcontrollers or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, and/or signal conditioning and buffering electronics. The control module 30 may be configured to automatically perform one or more control/processing routines that may be embodied as software or firmware associated with the module 30.

The hydraulic control system 32 may be operable to selectively engage the one or more fluidly-actuated torque-transmitting devices 24 of the transmission 14, and may include, for example, a fluid pump 34 associated with the engine 12, one or more electronically actuated control valves 36, 38 40, one or more check valves 42, 44, and an accumulator 46.

In one configuration, the fluid pump 34 may be mechanically driven by a rotating member 50 of the engine 12, and may be operable to selectively communicate a hydraulic fluid 52 from a sump 54 to a fluid conduit 56 associated with the hydraulic control system 32. The sump 54 generally serves as a fluid reservoir where excess hydraulic fluid 52 may be stored when not performing work. A first check valve 42 may prevent back flow of the pressurized hydraulic fluid into the pump 34 when the pump 34 is not operational. In other configurations, electrically driven fluid pumps may similarly be used.

A first control valve 36 may selectively control the flow of hydraulic fluid 52 from the hydraulic control system 32 to the fluidly-actuated torque-transmitting device 24 at the direction of the control module 30. Likewise, an optional second control valve 38 may selectively control the flow of hydraulic fluid 52 from the fluidly-actuated torque-transmitting device 24 to the sump 54.

The accumulator 46 operates as an energy storage device that maintains the non-compressible hydraulic fluid 52 under pressure by an external source. In the example provided, the accumulator 46 is a spring type or gas filled type accumulator having a spring or compressible gas that provides a compressive force on the hydraulic fluid 52 within the accumulator 46. It should be appreciated, however, that the accumulator 46 may be of other types, such as a gas-charged type, without departing from the scope of the present invention. Accordingly, the accumulator 46 may be operable to supply pressurized hydraulic fluid 52 back to the main fluid conduit 56 when an immediate charge is required. The first check valve 42 may be configured to constrain the accumulator-supplied charge solely within the fluid circuit and may prevent the pressurized hydraulic fluid 52 from returning to the pump 34. Therefore, a charged (fluid-filled) accumulator 46 may effectively replace or augment the pump 34 as the source of pressurized hydraulic fluid 52, thereby eliminating the need for the pump 34 to run continuously and/or the need for the pump to be oversized to accommodate rapid clutch-fills.

In one configuration, the accumulator 46 may be in fluid communication with the remainder of the hydraulic control system 32 though a third control valve 40 and a second check valve 44, disposed in a parallel arrangement. In other configurations, the second check valve 44 may be omitted.

The accumulator 46 may enable the vehicle 10 to automatically stop once the vehicle 10 is idled/brought to rest, and immediately re-start once an acceleration and/or restart signal is subsequently detected (referred to as an “automatic stop/start”). As may be appreciated automatic stop/starts may provide for an increase in fuel economy, since fuel is not being consumed merely to keep the engine idling. In such an event, the accumulator 46 is used to deliver fluid pressure to the one or more torque-transmitting devices 24 during an auto-start event and until the engine 12 and mechanically driven fluid pump 34 can achieve a speed sufficient to sustain the fluid pressure demands.

In this vein, as soon as the driver lets go of the brake to exit the automatic stop/start, the accumulator 46 is responsible for quickly charging the one or more torque-transmitting devices 24 (as the pump 34 is either “off” or at a low speed). In other configurations, the automatic stop/start may be exited upon other vehicle events/conditions, such as for example, a low battery state of charge, a high or low transmission fluid temperature, a high or low ambient air temperature, a detected fault in a vehicle system, or other such events/conditions. Once the engine 12 and pump 34 are allowed to spool to a minimum operating speed, hydraulic pressure may then be supplied predominantly by the fluid pump 34. If the fluid pressure within the accumulator 46 is insufficient to cause this initial clutch-engagement, however, the control module 30 may be configured to disallow the engine 12 from shutting off at an idle condition. Said another way, only when the accumulator 46 is adequately charged will an automatic stop/start event be allowed. This protection serves to preserve clutch life and provide a smooth re-start to the driver. If the accumulator charge is insufficient to fully pressurize a clutch, that clutch could excessively slip, which may result in an engine flare, a harsh clutch apply, or increased clutch wear (reduced clutch life).

The temperature of the hydraulic fluid 52 may have a direct effect on the viscosity of the fluid 52, and thus the rate at which the accumulator 46 may charge the one or more torque-transmitting devices 24. If the hydraulic fluid 52 is exceptionally cold (e.g., −20 degrees Celsius), for example, it may take 2-4 times as long to fill a clutch apply volume than when the fluid 52 is at a higher temperature (e.g., 20 degrees Celsius).

In one configuration, the vehicle 10 may include a temperature sensor 70 within (or proximate to) the sump 54 to directly measure the temperature of the working hydraulic fluid 52. This sensor may be a multi-purpose sensor that may be included with the vehicle 10 to monitor for over-temperature conditions. Unfortunately, the fluid within the accumulator 46 may be contained for extended periods of time without mixing with the fluid 52 in the sump 54. Therefore, the temperature of the sump 54 may not always properly reflect the temperature of the fluid within the accumulator 46. A difference in temperature may also be attributed to the physical location of the accumulator 46, which may or may not be located within the transmission. Despite this, a usable estimate of the fluid temperature within the accumulator may be desirable to more accurately tune the system behavior.

In one configuration, the control module 30 may use the sensed temperature of the sump fluid together with the fill behavior of the accumulator to maintain a running estimate of the temperature of the fluid within the accumulator 46. If the temperature of the fluid within the accumulator is outside of an acceptable temperature range, the control module 30 may take certain remedial measures to avoid any undesirable response during an automatic stop/start.

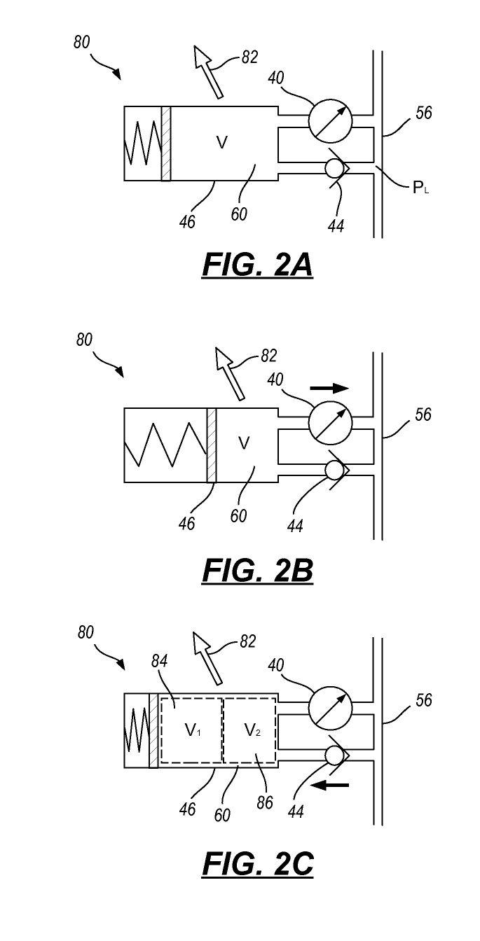

FIGS. 2A, 2B, and 2C schematically represent an accumulator fluid model 80 that may be used by the control module 30 to maintain an estimate of fluid temperature within the accumulator 46. As shown, the accumulator fluid model 80 may be defined by 3 general states: fluid storage (FIG. 2A); fluid release (FIG. 2B); and fluid intake (FIG. 2C).

During fluid storage (FIG. 2A), it may be assumed that the fluid within the accumulator 46 has a total volume V (i.e., total volume of fluid 60), and is generally homogenous across the entire volume V. During fluid storage, the only heat transfer may be through a heat loss to the external environment, which is generally represented by arrow 82. This heat loss 82 may cause a temperature change in the fluid that may be a function of the volume V of fluid, the temperature of the fluid T_{f}, and the temperature of the external environment Tₐ (ambient temperature) and also of the material surface material and any insulation around it.

During fluid release (FIG. 2B), there may continue to be heat transfer to the external environment (arrow 82), though the volume of fluid V would be decreasing. As such, the temperature change of the fluid may accelerate.

Finally, during fluid intake (FIG. 2C), the residual volume of fluid 84 (V₁) at a first temperature (T₁) may mix with a new volume of fluid 86 (V₂) that may be at a second temperature (T₂). The total accumulator volume (V) may therefore be the sum of the residual volume 84, and the intake volume 86 (i.e., V=V₁+V₂). Accordingly, the new temperature of the fluid T_{f} (following a mixing of the two fluids) may be represented by:

$${T}_{f} = \frac{{V}_{1}}{{V}_{1} + {V}_{2}} {T}_{1} + \frac{{V}_{2}}{{V}_{1} + {V}_{2}} {T}_{2}$$

The temperature T₂ of the new volume of fluid 86 (V₂) may be measured by the temperature sensor 70 within (or proximate to) the sump 54. Additionally, the volume of the new, intake fluid 86 (V₂) may be either measured using a flow sensor, pressure sensor in the accumulator, or estimated using a model of the system. For example, by monitoring the occurrence of charges and discharges of the accumulator, together with line pressure, the maximum accumulator volume, and/or maximum pressure of the accumulator, the control module 30 may be able to infer total fluid flow to/from the accumulator 46. In another configuration, the new volume of fluid 86 (V₂) may be estimated using a pressure sensor that may be in fluid communication with the accumulator 46. The pressure sensor may monitor a pressure of the accumulator 46 before and after a charge, and determine an approximate change in volume, from change in pressure.

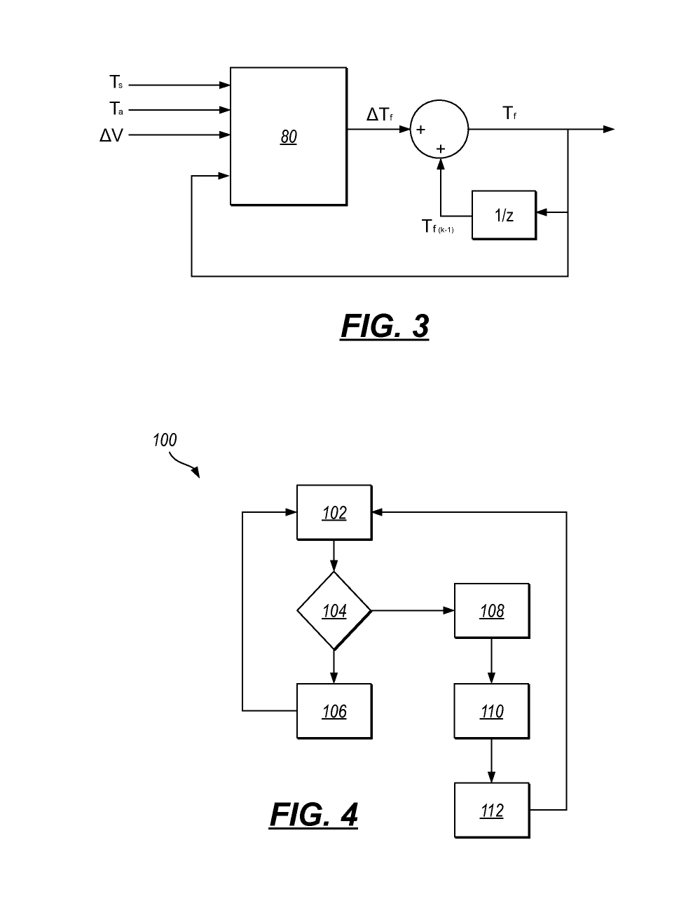

As schematically illustrated in FIG. 3, using the above-described accumulator fluid model 80, together with the temperature of the working fluid (e.g., T_{S} measured at the sump 54), the ambient temperature (Tₐ measured, for example, using an ambient temperature sensor, or temperature sensor in the air intake system of the engine 12), and fluid flow to/from the accumulator (i.e., change in volume, ΔV), the control module 30 may estimate a change in the temperature (ΔT_{f}) of the fluid, which may be added to a previously estimated temperature (T_{fk-1}—obtained via a unit delay block 1/z) to estimate an updated temperature of the fluid retained within the accumulator (T_{f}). As may be appreciated, absent any fluid intake, T_{f} may decay toward the ambient temperature Tₐ over time. Due to the non-linearity of the temperature decay, and the variability of the volume intake, the above described equations may be pre-calculated based on the physical parameters of the system, and stored in a look-up table for quick access. Alternatively, the control module may be configured to approximate the fluid temperature using analytical formulae or one or more linear approximation methods that area known in the art.

FIG. 4 schematically illustrates a control method 100 that may adjust the operation of the vehicle 10 according to the maintained accumulator fluid temperature T_{f}. More specifically, the control method 100 may be used to selectively prevent an automatic engine stop and take certain remedial measures if the fluid temperature T_{f} is outside of a predetermined range. The control method 100 may be executed by the control module 30, and may be embodied by software or firmware.

As shown, the method 100 may begin at step 102, where the control module 30 obtains an estimated accumulator fluid temperature T_{f} from the accumulator fluid model 80. In step 104, the control module 30 may compare the estimated accumulator fluid temperature T_{f} to an acceptable temperature range. If the temperature is within the acceptable range, in step 106, the control module may not prevent an automatic stop if requested. If the estimated accumulator fluid temperature T_{f} is outside of the acceptable range, then in step 108, the control module 30 may prevent the automatic stop. In step 110, the control module 30 may discharge the accumulator 46, and in step 112, the control module 30 may recharge the accumulator 46. Additionally, in step 112, the commanded line pressure might be changed in order to release a specific or desired amount of volume from the accumulator.

By discharging and recharging the accumulator (steps 110 and 112), the accumulator 46 may, for example, release any cold, contained fluid back to the hydraulic control system 32 where it may mix with other fluid, for example, within the sump 54. The control module 30 may delay any recharging of the accumulator 46 (step 112) until the temperature of the fluid within the sump 54 is within the acceptable range provided in step 104.

In one configuration, the above-described control method 100 may be performed only when an automatic stop is requested. In another configuration, the above-described control method 100 may be performed continuously as a means of ensuring that the hydraulic control system 32 is always properly situated to allow an automatic stop to occur. As an additional measure, the control module 30 may force a discharge/recharge (steps 110 and 112) within a predetermined time of the start of each driving session (i.e., for every key-on event). In this manner, any fluid that has been stored in the accumulator for a prolonged period of time, and which likely has settled to the ambient temperature, will be expelled and replaced by fluid that has been warmed by the engine 12. In another embodiment the accumulator temperature model could be running while the vehicle is in an off-state, such that the accumulator temperature at key start would be known.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A method of preventing an automatic engine stop comprising:
estimating a temperature of a volume of fluid within a hydraulic accumulator, wherein the hydraulic accumulator is in selective fluid communication with a fluidly-actuated torque-transmitting device coupled to an internal combustion engine;
comparing the estimated fluid temperature to a temperature range; and
preventing the internal combustion engine from automatically stopping if the estimated fluid temperature is outside of the temperature range.

2. The method of claim 1, wherein estimating a temperature of the volume of fluid includes:
computing a first temperature change of the volume of fluid that is attributable to heat transfer from the volume of fluid to a surrounding environment.

3. The method of claim 2, further comprising introducing fluid from a hydraulic circuit into the volume of fluid; and
wherein estimating a temperature of the volume of fluid further includes computing a second temperature change in the volume of fluid that is attributable to fluid mixing with the introduced fluid.

4. The method of claim 1, further comprising discharging the volume of fluid within the hydraulic accumulator if the estimated fluid temperature is outside of the temperature range.

5. A vehicle comprising:
an internal combustion engine configured to combust a fuel to provide a mechanical rotary output, and automatically stop combusting the fuel if vehicle motion is prevented by a braking device;
a transmission coupled with the internal combustion engine and including a fluidly actuated torque transmitting device configured to selectively transmit the rotary output of the internal combustion engine to a vehicle wheel;
a hydraulic control system in fluid communication with the torque transmitting device, the hydraulic control system including a fluid circuit in fluid communication with a fluid sump and a hydraulic accumulator, wherein the hydraulic accumulator is configured to selectively retain a volume of fluid;
a control module in communication with the hydraulic control system and with the internal combustion engine, the control module configured to:
estimate a temperature of the volume of fluid within a hydraulic accumulator;
compare the estimated fluid temperature to a temperature range; and
prevent the internal combustion engine from automatically stopping if the estimated fluid temperature is outside of the temperature range.

6. The vehicle of claim 5, wherein the control module is configured to estimate a temperature of the volume of fluid by computing a first temperature change of the volume of fluid that is attributable to heat transfer from the volume of fluid to a surrounding environment.

7. The vehicle of claim 6, wherein a fluid is configured to flow from the fluid circuit into the hydraulic accumulator and mix with the volume of fluid; and
wherein the control module is configured to estimate a temperature of the volume of fluid by computing a second temperature change in the volume of fluid that is attributable to fluid mixing with the introduced fluid.

8. The vehicle of claim 5, wherein the control module is configured to discharge the volume of fluid within the hydraulic accumulator if the estimated fluid temperature is outside of the temperature range.

9. The vehicle of claim 5, further comprising a temperature sensor disposed within the fluid sump, and configured to monitor the temperature of a fluid within the fluid sump.

10. A vehicle comprising:
an internal combustion engine configured to combust a fuel to provide a mechanical rotary output, and automatically stop combusting the fuel if a vehicle motion is prevented by a braking device;
a transmission coupled with the internal combustion engine and including a fluidly actuated torque transmitting device configured to selectively transmit the rotary output of the internal combustion engine to a vehicle wheel;
a hydraulic control system in fluid communication with the torque transmitting device, the hydraulic control system including a fluid circuit in fluid communication with a fluid sump and a hydraulic accumulator, wherein the hydraulic accumulator is configured to selectively retain a volume of fluid;
a control module in communication with the hydraulic control system and with the internal combustion engine, the control module configured to:
maintain an estimate of a temperature of the volume of fluid within the hydraulic accumulator;
estimate a change in the temperature of the volume of fluid within a hydraulic accumulator using the estimate of a temperature of the volume of fluid, an ambient temperature, and a temperature of a fluid within the fluid sump;
update the estimate of temperature of the volume of fluid with the estimated change in temperature;
compare the updated estimated fluid temperature to a temperature range; and
prevent the internal combustion engine from automatically stopping if the estimated fluid temperature is outside of the temperature range.

11. The vehicle of claim 10, wherein the control module is configured to estimate the change in the temperature of the volume of fluid by computing a first temperature change of the volume of fluid that is attributable to heat transfer from the volume of fluid to a surrounding environment.

12. The vehicle of claim 11, wherein a fluid is configured to flow from the fluid sump into the hydraulic accumulator and mix with the volume of fluid; and
wherein the control module is configured to estimate a temperature of the volume of fluid by computing a second temperature change in the volume of fluid that is attributable to fluid mixing with the introduced fluid.

13. The vehicle of claim 10, wherein the control module is configured to discharge the volume of fluid within the hydraulic accumulator if the updated estimate of fluid temperature is below the temperature range.

14. The vehicle of claim 10, further comprising a temperature sensor disposed within the fluid sump, and configured to monitor the temperature of a fluid within the fluid sump.
